(19) United States
(12) Patent Application Publication
(10) Pub. No.: US 2026/0086961 A1
(43) Pub. Date: Mar. 26, 2026

(54) TECHNIQUES FOR INCREASING CAPACITY OF DRAM USING A COMMON DRAM DIE

(71) Applicant: NVIDIA Corporation, Santa Clara, CA (US)

(72) Inventors: Kuljit Singh BAINS, Olympia, WA (US); Jangryul KIM, Sunnyvale, CA (US); Wen-Hung LO, Saratoga, CA (US); Michael Ivan HALFEN, San Francisco, CA (US); John W. BROOKS, San Jose, CA (US)

(21) Appl. No.: 19/306,821

(22) Filed: Aug. 21, 2025

Related U.S. Application Data
(60) Provisional application No. 63/699,693, filed on Sep. 26, 2024.

(51) Int. Cl. G06F 13/16

(52) U.S. Cl. CPC G06F 13/1673; G06F 13/1678

(57) ABSTRACT

Various embodiments include a memory device that is capable of being configured with a wide data bus interface or a narrow data bus interface. The wide data bus interface is suitable for low-cost applications, such as smart phones and laptop computers. The narrow data bus interface is suitable for applications where high memory density is desirable, such as data servers in a data center. The wide data bus is twice the width of the narrow data bus width. In the narrow data bus configuration, the memory device transfers twice the number of data words in a single burst transfer relative to the wide data bus width configuration. As a result, the number of bits transferred in a single burst transfer is the same regardless of the configuration, thereby simplifying control logic of the memory device. The memory device can further accommodate various packaging options that facilitate high density memory designs.

### CROSS-REFERENCE TO RELATED APPLICATIONS

This application claims priority benefit of the United States Provisional Patent Application titled, “TECHNIQUES FOR INCREASING CAPACITY OF DRAM USING A COMMON DRAM DIE,” filed on Sep. 26, 2024, and having Ser. No. 63/699,693. The subject matter of this related application is hereby incorporated herein by reference.

### BACKGROUND

### Field of the Various Embodiments

Various embodiments relate generally to computer memory devices and, more specifically, to techniques for increasing capacity of DRAM using a common DRAM die.

### Description of the Related Art

A computer system generally includes, among other things, one or more processing units, such as central processing units (CPUs) and/or graphics processing units (GPUs), and one or more memory systems. One type of memory system is referred to as system memory, which is accessible to both the CPU(s) and the GPU(s). Another type of memory system is graphics memory, which is typically accessible only by the GPU(s). These memory systems comprise multiple memory devices. One example memory device employed in system memory and/or graphics memory is synchronous dynamic-random access memory (SDRAM or, more succinctly, DRAM).

DRAM devices can be configured in various ways depending on the application. For example, DRAM devices can be configured to have wider data bus widths, such as 16 data bits, 12 data bits, or 8 data bits. With a wider data bus width, a total data bus width of a given size can be achieved with fewer memory devices. For example, a total data bus width of 48 bits using the aforementioned memory devices can be achieved with 3 memory devices, 4 memory devices, or 6 memory devices, respectively. By keeping the total number of memory devices low, DRAM devices with wider data bus widths are suitable for applications where low cost is important, such as smart phones, tablet computers, laptop computers, and/or the like.

Alternatively, DRAM devices can be configured to have narrower data bus widths, such as a data bus width equal to half the width of the aforementioned DRAM devices. Such memory devices can have a data bus width of 8 data bits, 6 data bits, or 4 data bits, respectively. In order to achieve a total data bus width of 48 bits using these memory devices with narrower data bus widths would require 6 memory devices, 8 memory devices, or 12 memory devices, respectively. As a result, these memory devices are less suitable for applications where low cost is important. However, using DRAM devices with narrower data bus widths can be advantageous for applications where high memory density is desirable, such as storage servers used for data centers, media servers used for video streaming, and/or the like. DRAM devices for such applications are typically packaged as a multi-die package, such that a single package includes multiple DRAM dies.

In addition to having different data bus widths, DRAM devices configured for different applications can have different channel interfaces, different data access patterns, different timing requirements, and/or the like. As a result, conventional DRAM devices have different internal dies, each die having different control logic for managing operations for the DRAM device. One disadvantage with this approach for having different dies for different DRAM devices is that manufacturing complexity increases with the need to design and fabricate many different types of DRAM device dies for different applications. Further, as the number of different dies for different DRAM devices increases, the complexity of managing inventory also increases. For example, if a manufacturer fabricates too many pieces of one DRAM memory die type and not enough pieces of another DRAM memory die type, then the manufacturer may have too much inventory of laptop memory devices if demand falls for that application. At the same time, the manufacturer may have too little inventory of data server memory devices if demand rises for that application.

One possible solution for this problem is to manufacture a DRAM device that can accommodate all of the aforementioned applications. Such a DRAM device would need a superset of the internal control logic found in the different conventional DRAM devices, so that the DRAM device can accommodate the different data prefetch sizes, different channel interfaces, different data access patterns, and/or the like for multiple conventional DRAM devices. For example, a conventional DRAM device with a 12-bit data bus width could prefetch 256 data bits at a time from the DRAM memory core, while a conventional DRAM device with a 6-bit data bus width could prefetch 128 data bits at a time from the DRAM memory core. A DRAM device to replace these two conventional DRAM devices would need control logic that can prefetch either 256 data bits at a time or 128 bits at a time, depending on the DRAM device configuration. However, such control logic can be significantly complex, which can increase complexity, die area, and cost for DRAM devices deployed in applications that do not require such complex control logic. Further, such complex control logic may not be able to conform with the constraints of different industry standard requirements for DRAM devices. Therefore, DRAM devices designed with this approach may not be compatible with one or more industry standard interfaces and, therefore, may not be compatible for use in certain applications.

As the foregoing illustrates, what is needed in the art are more effective techniques for manufacturing DRAM devices for different applications.

### SUMMARY

Various embodiments of the present disclosure set forth a memory device. The memory device includes a first memory die. The first memory die includes a first memory core, a first prefetch buffer coupled to the first memory core and configured to store data for at least a portion of the first memory core, and a first data bus interface coupled to the first prefetch buffer and configurable to have one of a first bit width or a second bit width. When configured to have the first bit width, the first data bus interface transfers data between the first prefetch buffer and an external device as a burst of data transfers with a first burst length. When configured to have the second bit width, the first data bus interface transfers data between the first prefetch buffer and the external device as a burst of data transfers with a second burst length that is different from the first burst length.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, a common die can be configured with a wide data bus width or with a narrow data bus width that is half the bus width relative to the wide data bus width. Further, by doubling the data burst length when the data bus width is halved, the same internal prefetch size can be maintained. By contrast, conventional approaches maintain the same burst length when the data bus width is halved, thereby reducing channel efficiency by 50%. Further, packaging for this common die can include additional read data strobes, write clocks, and data bus pinout options, making the resulting package easier to stack vertically and achieving even higher memory density at the system level. With these techniques, a single common DRAM memory die can be configured and packaged to accommodate different data bus widths for different applications without appreciably increasing channel logic complexity or die surface area. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the various embodiments;

FIGS. 2A-2B set forth block diagrams for different configurations of a DRAM device included in system memory and/or parallel processing memory of the computer system of FIG. 1, according to various embodiments;

FIG. 3 illustrates a system configuration using DRAM devices of FIG. 2A, according to various embodiments;

FIG. 4 illustrates a system configuration using DRAM devices of FIG. 2B, according to various embodiments;

FIG. 5 illustrates how DRAM dies can be vertically stacked in a multi-die DRAM package, according to various embodiments;

FIG. 6 illustrates a format for DRAM device data transfer with a burst length of 48 beats, according to various embodiments;

FIG. 7 set forth timing diagrams illustrating command bus optimization for a DRAM device that supports a burst length of 48 beats, according to various embodiments;

FIG. 8 is a timing diagram illustrating chip select training for a DRAM device with a 6-bit data bus width, according to various embodiments; and

FIG. 9 is a timing diagram illustrating command bus training for a DRAM device with a 6-bit data bus width, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

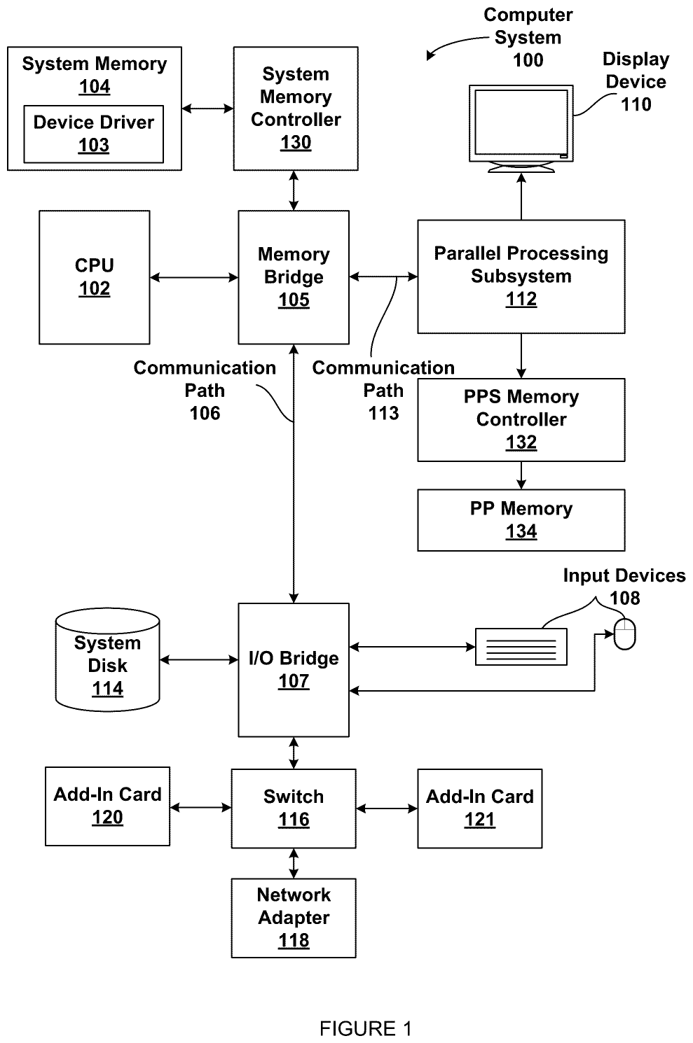

FIG. 1 is a block diagram of a computer system 100 configured to implement one or more aspects of the various embodiments. As shown, computer system 100 includes, without limitation, a central processing unit (CPU) 102 and a system memory 104 coupled to a parallel processing subsystem 112 via a memory bridge 105 and a communication path 113. Memory bridge 105 is coupled to system memory 104 via a system memory controller 130. Memory bridge 105 is further coupled to an I/O (input/output) bridge 107 via a communication path 106, and I/O bridge 107 is, in turn, coupled to a switch 116. Parallel processing subsystem 112 is coupled to parallel processing memory 134 via a parallel processing subsystem (PPS) memory controller 132.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to a display device 110 that may be any conventional cathode ray tube, liquid crystal display, light-emitting diode display, and/or the like. In such embodiments, parallel processing subsystem 112 incorporates circuitry optimized for graphics and video processing, including, for example, video output circuitry. Such circuitry may be incorporated across one or more parallel processing units (PPUs) included within parallel processing subsystem 112. In some embodiments, each PUPS comprises a graphics processing unit (GPU) that may be configured to implement a graphics rendering pipeline to perform various operations related to generating pixel data based on graphics data supplied by CPU 102 and/or system memory 104. Each PPU may be implemented using one or more integrated circuit devices, such as programmable processors, application specific integrated circuits (ASICs), or memory devices, or in any other technically feasible fashion

In some embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other elements of FIG. 1 to form a single system. For example, parallel processing subsystem 112 may be integrated with CPU 102 and other connection circuitry on a single chip to form a system on chip (SoC).

In operation, CPU 102 is the master processor of computer system 100, controlling and coordinating operations of other system components. In particular, CPU 102 issues commands that control the operation of PPUs within parallel processing subsystem 112. In some embodiments, CPU 102 writes a stream of commands for PPUs within parallel processing subsystem 112 to a data structure (not explicitly shown in FIG. 1) that may be located in system memory 104, PP memory 134, or another storage location accessible to both CPU 102 and PPUs. A pointer to the data structure is written to a pushbuffer to initiate processing of the stream of commands in the data structure. The PPU reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

Each PPU includes an I/O (input/output) unit that communicates with the rest of computer system 100 via the communication path 113 and memory bridge 105. This I/O unit generates packets (or other signals) for transmission on communication path 113 and also receives all incoming packets (or other signals) from communication path 113, directing the incoming packets to appropriate components of the PPU. The connection of PPUs to the rest of computer system 100 may be varied. In some embodiments, parallel processing subsystem 112, which includes at least one PPU, is implemented as an add-in card that can be inserted into an expansion slot of computer system 100. In other embodiments, the PPUs can be integrated on a single chip with a bus bridge, such as memory bridge 105 or I/O bridge 107. Again, in still other embodiments, some or all of the elements of the PPUs may be included along with CPU 102 in a single integrated circuit or system of chip (SoC).

CPU 102 and PPUs within parallel processing subsystem 112 access system memory via a system memory controller 130. System memory controller 130 transmits signals to the memory devices included in system memory 104 to initiate the memory devices, transmit commands to the memory devices, write data to the memory devices, read data from the memory devices, and/or the like. One example memory device employed in system memory 104 is double-data rate SDRAM (DDR SDRAM or, more succinctly, DDR). DDR memory devices perform memory write and read operations at twice the data rate of previous generation single data rate (SDR) memory devices.

In addition, PPUs and/or other components within parallel processing subsystem 112 access PP memory 134 via a parallel processing subsystem (PPS) memory controller 132. PPS memory controller 132 transmits signals to the memory devices included in PP memory 134 to initiate the memory devices, transmit commands to the memory devices, write data to the memory devices, read data from the memory devices, and/or the like. One example memory device employed in PP memory 134 synchronous graphics random access memory (SGRAM), which is a specialized form of SDRAM for computer graphics applications. One particular type of SGRAM is graphics double-data rate SGRAM (GDDR SDRAM or, more succinctly, GDDR). Compared with DDR memory devices, GDDR memory devices are configured with a wider data bus, in order to transfer more data bits with each memory write and read operation. By employing double data rate technology and a wider data bus, GDDR memory devices are able to achieve the high data transfer rates typically needed by PPUs.

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

It will be appreciated that the core architecture described herein is illustrative and that variations and modifications are possible. Among other things, the computer system 100 of FIG. 1, may include any number of CPUs 102, parallel processing subsystems 112, or memory systems, such as system memory 104 and parallel processing memory 134, within the scope of the disclosed embodiments. Further, as used herein, references to shared memory may include any one or more technically feasible memories, including, without limitation, a local memory shared by one or more PPUs within parallel processing subsystem 112, memory shared between multiple parallel processing subsystems 112, a cache memory, parallel processing memory 134, and/or system memory 104. Please also note, as used herein, references to cache memory may include any one or more technically feasible memories, including, without limitation, an L1 cache, an L1.5 cache, and L2 caches. In view of the foregoing, persons of ordinary skill in the art will appreciate that the architecture described in FIG. 1 in no way limits the scope of the various embodiments of the present disclosure.

### Increasing Capacity of DRAM Using a Common DRAM Die

Various embodiments include an improved DRAM device with a common memory die that can be configured with different data bus widths for different applications. The memory device can be configured with a wide data bus width and a specified data burst length. Alternatively, the memory device can be configured with a narrow data bus width that is half of the wide data bus width and a data burst length that is twice the specified data burst length. By doubling the burst length when the data bus width is halved, the two configurations of the memory device maintain the same internal prefetch size. In some examples, the prefetch size of the memory device can be 288 bits. With this prefetch size, the memory device can be configured with a 12-bit data bus width and a burst length of 24 beats or with a 6-bit data bus width and a burst length of 48 beats. Maintaining the same internal prefetch size for these two configurations can simplify the channel control logic for the memory die.

Further, the common die can be packaged into different configurations. For example, the package for the common memory die includes multiple read data strobes and write clock pins, thereby allowing read data strobe inputs and write clock inputs of the memory die to be routed to different pins of the memory device package. Similarly, the common memory die can include an internal data bus that allows, for example, all 12 bits to be routed to pins of the memory device package or only 6 of the 12 bits to be routed to pins of the memory device package. In this latter configuration, the memory die includes a mode whereby either the six most significant data pins or the six least significant data pins of the 12-bit data bus can be selected to route to pins of the memory device package.

These package options allow more memory devices to be placed on a single rank, thereby doubling memory capacity without increasing surface area of the memory device package. As a result, higher memory capacity can be achieved without increasing the surface area of the package, thereby providing additional memory capacity for applications that need large amounts of memory, such as data servers in a data center.

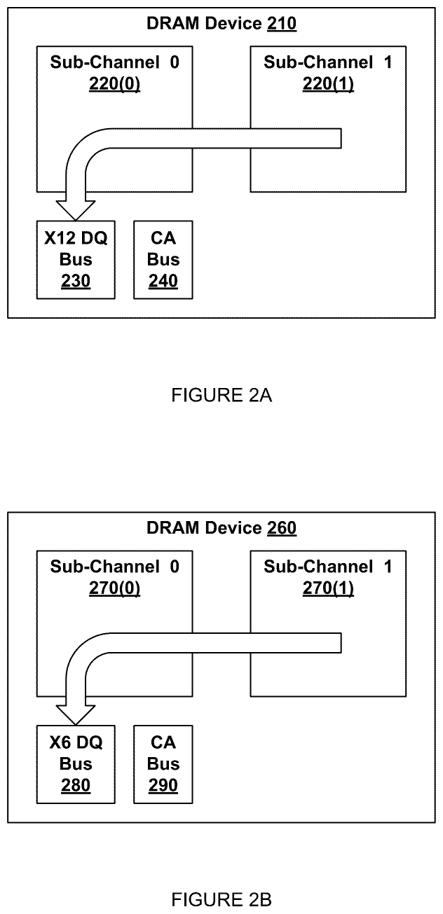

FIGS. 2A-2B set forth block diagrams for different configurations of a DRAM device 210, 260 included in system memory 104 and/or parallel processing memory 134 of the computer system 100 of FIG. 1, according to various embodiments. As shown in FIG. 2A, a first configuration of a DRAM device 210 includes, without limitation, two sub-channels, namely sub-channel 0 220(0) and sub-channel 1 220(1). DRAM device 210 further includes, without limitation, a 12-bit data bus (X12 DQ bus) 230 and a command (CA) bus 240.

In operation, data is stored in and retrieved from the memory core (not shown) of DRAM device 210. DRAM device 210 receives commands, such as commands to perform a read operation, a write operation, a prefetch operation, and/or the like via CA bus 240.

DRAM device 210 stores data in the memory core in response to receiving a write operation via CA bus 240. DRAM device 210 retrieves data from the memory core in response to receiving a read operation via CA bus 240. To reduce the number of individual write operations and read operations directed to the memory core, DRAM device 210 accesses data in the memory core via prefetch operations. More specifically, DRAM device 210 can retrieve a number of data words from the memory core via a prefetch operation and store the number of data words in an internal prefetch buffer. Similarly, DRAM device 210 can store the number of data words of the internal prefetch buffer in the memory core. In some embodiments, the prefetch buffer stores 288 bits, including 256 data bits and 32 parameter bits. DRAM device 210 transfers data between the prefetch buffer and external devices in the form of a burst, where a burst is a sequence of consecutive data transfers, and each data transfer is the width of the data bus, namely, 12 bits. The consecutive data transfers are performed over successive clock cycles, and each data transfer of a burst includes a data field referred to as a beat. Therefore, to transfer the 288 bits of the prefetch buffer and an external device, DRAM device 210 performs a burst with a burst length of 24 beats of 12 bits per beat.

Taken together, sub-channel 0 220(0) and sub-channel 1 220(1) provide a 12-bit interface to the data in the prefetch buffer via X12 DQ bus 230. Sub-channel 0 220(0) and sub-channel 1 220(1) can provide a 12-bit interface via a single 12-bit channel via X12 DQ bus 230, as shown in FIG. 2A. For example, DRAM device 210 can be configured as two sub-channels, sub-channel 0 220(0) and sub-channel 1 220(1), configured as a single 12-bit channel with a burst length of 24 beats. Successive data access operations, such as read operations or write operations, can be directed to the same sub-channel. Additionally or alternatively, successive data access operations can alternate between sub-channel 0 220(0) and sub-channel 1 220(1). Additionally or alternatively, sub-channel 0 220(0) and sub-channel 1 220(1) can each provide a 12-bit interface via separate subchannels (not shown in FIG. 2A).

During a read operation, DRAM device 210 transmits the 288 bits of the prefetch buffer as a data packet via X12 DQ bus 230. DRAM device 210 transmits the data packet as a burst of 24 beats where each beat includes a data field of 12 bits. Similarly, during a write operation, DRAM device 210 stores the received data in the 288 bits of the prefetch buffer as a data packet via X12 DQ bus 230. DRAM device 210 receives the data packet as a burst of 24 beats where each beat includes a data field of 12 bits.

In addition, DRAM device 210 can include other signals (not shown) to facilitate various operations of DRAM device 210. In that regard, DRAM device 210 can include one or more chip select (CS) signals that transition to enable or disable DRAM device. DRAM device 210 can include one or more write clock (WCK) signals that synchronize data transferred to DRAM device 210. DRAM device 210 can further include one or more read clock (RCK) signals that synchronize data retrieved from DRAM device 210. DRAM device 210 can further include one or more data strobe (DS) signals that transition when data present on X12 DQ bus 230 is valid, such as data to be stored in DRAM device 210 during a write operation, data to be retrieved from DRAM device 210 during a read operation, and/or the like.

Configuring DRAM device 210 with a 12-bit data bus, such as X12 DQ bus 230, can be advantageous for applications where wider data bus widths are suitable. Wider data bus widths can be suitable where low cost is important, such as smart phones, tablet computers, laptop computers, and/or the like.

As shown in FIG. 2B, a second configuration of a DRAM device 260 includes, without limitation, two sub-channels, namely sub-channel 0 270(0) and sub-channel 1 270(1). DRAM device 260 further includes, without limitation, a 6-bit data bus (X6 DQ bus) 280 and a command (CA) bus 290.

In operation, data is stored in and retrieved from the memory core (not shown) of DRAM device 260. DRAM device 260 receives commands, such as commands to perform a read operation, a write operation, a prefetch operation, and/or the like via CA bus 290.

DRAM device 260 stores data in the memory core in response to receiving a write operation via CA bus 290. DRAM device 260 retrieves data from the memory core in response to receiving a read operation via CA bus 290. To reduce the number of individual write operations and read operations directed to the memory core, DRAM device 260 accesses data in the memory core via prefetch operations. More specifically, DRAM device 260 can retrieve a number of data words from the memory core via a prefetch operation and store the number of data words in an internal prefetch buffer. Similarly, DRAM device 260 can store the number of data words of the internal prefetch buffer in the memory core. In some embodiments, the prefetch buffer stores 288 bits, including 256 data bits and 32 parameter bits. DRAM device 260 transfers data between the prefetch buffer and external devices in the form of a burst, where a burst is a sequence of consecutive data transfers, and each data transfer is the width of the data bus, namely, 6 bits. The consecutive data transfers are performed over successive clock cycles, and each data transfer of a burst includes a data field referred to as a beat. Therefore, to transfer the 288 bits of the prefetch buffer and an external device, DRAM device 210 performs a burst with a burst length of 48 beats of 6 bits per beat.

Taken together, sub-channel 0 270(0) and sub-channel 1 270(1) provide a 6-bit interface to the data in the prefetch buffer via X6 DQ bus 280. Sub-channel 0 270(0) and sub-channel 1 270(1) can provide a 6-bit interface via a single 6-bit channel via X6 DQ bus 280, as shown in FIG. 2B. For example, DRAM device 260 can be configured as two sub-channels, sub-channel 0 270(0) and sub-channel 1 270(1), configured as a single 6-bit channel with a burst length of 48 beats. Successive data access operations, such as read operations or write operations, can be directed to the same sub-channel. Additionally or alternatively, successive data access operations can alternate between sub-channel 0 270(0) and sub-channel 1 270(1). Additionally or alternatively, sub-channel 0 270(0) and sub-channel 1 270(1) can each provide a 6-bit interface via separate subchannels (not shown in FIG. 2B).

During a read operation, DRAM device 260 transmits the 288 bits of the prefetch buffer as a data packet via X6 DQ bus 280. DRAM device 260 transmits the data packet as a burst of 48 beats where each beat includes a data field of 6 bits. Similarly, during a write operation, DRAM device 260 stores the received data in the 288 bits of the prefetch buffer as a data packet via X6 DQ bus 280. DRAM device 260 receives the data packet as a burst of 48 beats where each beat includes a data field of 6 bits.

In addition, DRAM device 260 can include other signals (not shown) to facilitate various operations of DRAM device 260. In that regard, DRAM device 210 can include one or more chip select (CS) signals that transition to enable or disable DRAM device. DRAM device 260 can include one or more write clock (WCK) signals that synchronize data transferred to DRAM device 260. DRAM device 260 can further include one or more read clock (RCK) signals that synchronize data retrieved from DRAM device 260. DRAM device 260 can further include one or more data strobe (DS) signals that transition when data present on X6 DQ bus 280 is valid, such as data to be stored in DRAM device 260 during a write operation, data to be retrieved from DRAM device 260 during a read operation, and/or the like.

Configuring DRAM device 260 with a 6-bit data bus, such as X6 DQ bus 280, can be advantageous for applications where narrower data bus widths are suitable. Narrower data bus widths can be suitable where high memory density is important, such as storage servers used for data centers, media servers used for video streaming, and/or the like.

With a single common die, a DRAM device could be configured as DRAM device 210 with a 12-bit interface and a burst length of 24 beats or as DRAM device 260 with a 6-bit interface and a burst length of 48 beats. The configuration can be selected during packaging via a hardware mechanism, such as through one or more configuration fuses, wires, signal traces, and/or other hardwired components on the surface of the memory die of the DRAM device. Additionally or alternatively, configuration can be selected at run time via a software mechanism, such as through one or more programmable register bits included in the memory die of the DRAM device. DRAM device 210 can be packaged as a single memory die within a single die DRAM package, as shown in FIG. 2A. Additionally or alternatively, multiple DRAM devices 210 can be packaged together as multiple dies within a multi-die DRAM package. Likewise, DRAM device 260 can be packaged as a single memory die within a single die DRAM package, as shown in FIG. 2B. Additionally or alternatively, multiple DRAM devices 260 can be packaged together as multiple dies within a multi-die DRAM package. With either DRAM device 210 or DRAM device 260, the number of memory dies in a multi-die DRAM package can be 1 memory die, 2 memory dies, 4 memory dies, 8 memory dies, 16 memory dies, and/or the like. The memory dies can be laid out horizontally and or stacked vertically within the multi-die DRAM package.

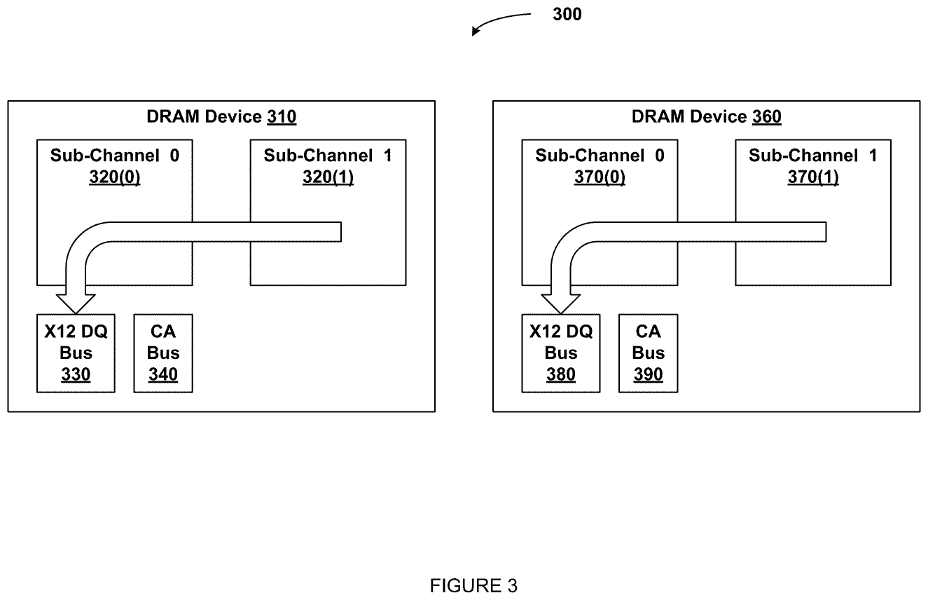

FIG. 3 illustrates a system configuration using DRAM devices 210 of FIG. 2A, according to various embodiments. As shown in FIG. 3, the system configuration includes, without limitation, a multi-die DRAM package 300, which further includes DRAM device 310 and DRAM device 360. Each of DRAM device 310 and DRAM device 360 is a memory die configured the same as DRAM device 210 of FIG. 2A.

DRAM device 310 includes, without limitation, two sub-channels, namely sub-channel 0 320(0) and sub-channel 1 320(1). DRAM device 310 further includes, without limitation, a 12-bit data bus (X12 DQ bus) 330 and a command (CA) bus 340. Sub-channel 0 320(0), sub-channel 1 320(1), X12 DQ bus 330, and CA bus 340 function substantially as described in conjunction with FIG. 2A.

DRAM device 360 includes, without limitation, two sub-channels, namely sub-channel 0 370(0) and sub-channel 1 370(1). DRAM device 360 further includes, without limitation, a 12-bit data bus (X12 DQ bus) 380 and a command (CA) bus 390. Sub-channel 0 370(0), sub-channel 1 370(1), X12 DQ bus 380, and CA bus 390 likewise function substantially as described in conjunction with FIG. 2A.

Taken together, DRAM device 310 and DRAM device 360 can provide a 24-bit interface via X12 DQ bus 330 and X12 DQ bus 380, respectively, with a burst length of 24 beats. Successive data access operations, such as read operations or write operations, can be directed to the same sub-channels. Additionally or alternatively, successive data access operations can alternate between sub-channels 0 and sub-channels 1 of DRAM device 310 and DRAM device 360, respectively.

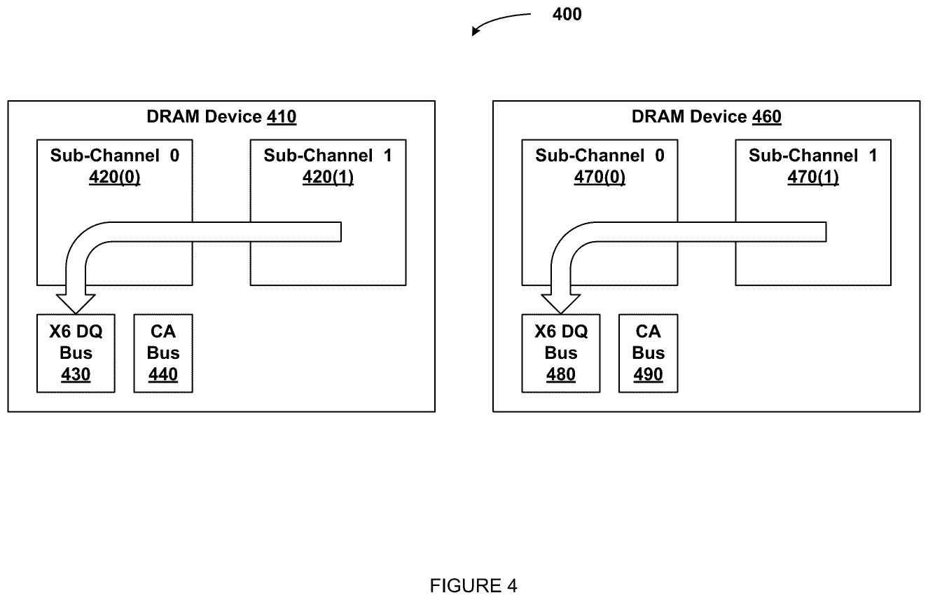

FIG. 4 illustrates a system configuration using DRAM devices 260 of FIG. 2B, according to various embodiments. As shown in FIG. 4, the system configuration includes, without limitation, a multi-die DRAM package 400, which further includes DRAM device 410 and DRAM device 460. Each of DRAM device 410 and DRAM device 460 is a memory die configured the same as DRAM device 260 of FIG. 2B.

DRAM device 410 includes, without limitation, two sub-channels, namely sub-channel 0 420(0) and sub-channel 1 420(1). DRAM device 410 further includes, without limitation, a 6-bit data bus (X6 DQ bus) 430 and a command (CA) bus 440. Sub-channel 0 420(0), sub-channel 1 420(1), X6 DQ bus 430, and CA bus 440 function substantially as described in conjunction with FIG. 2B.

DRAM device 460 includes, without limitation, two sub-channels, namely sub-channel 0 470(0) and sub-channel 1 470(1). DRAM device 460 further includes, without limitation, a 6-bit data bus (X6 DQ bus) 480 and a command (CA) bus 490. Sub-channel 0 470(0), sub-channel 1 470(1), X6 DQ bus 480, and CA bus 490 likewise function substantially as described in conjunction with FIG. 2B.

Taken together, DRAM device 410 and DRAM device 460 can provide a 12-bit interface via X6 DQ bus 430 and X6 DQ bus 480, respectively, with a burst length of 48 beats. Successive data access operations, such as read operations or write operations, can be directed to the same sub-channels. Additionally or alternatively, successive data access operations can alternate between sub-channels 0 and sub-channels 1 of DRAM device 410 and DRAM device 460, respectively.

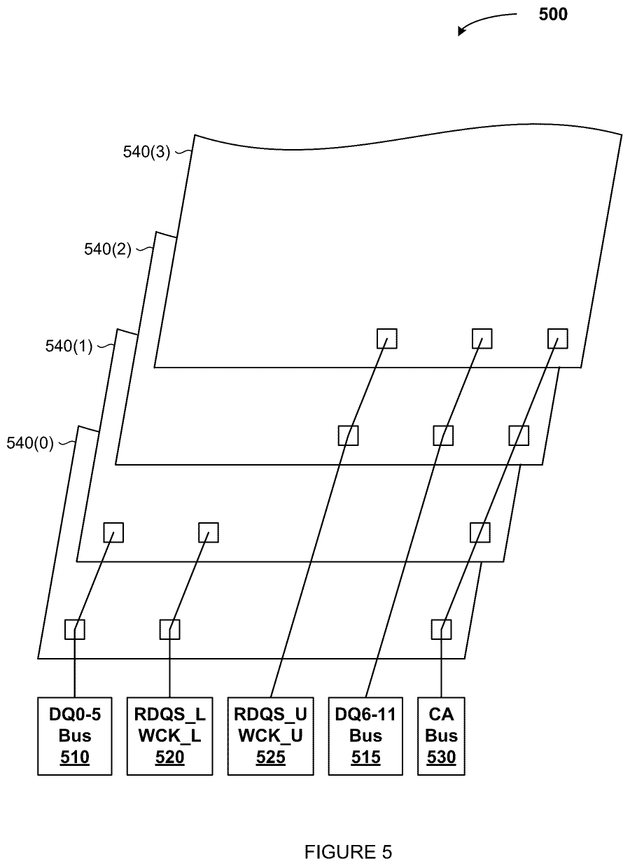

FIG. 5 illustrates how DRAM dies can be vertically stacked in a multi-die DRAM package 500, according to various embodiments. As shown, multi-die DRAM package 500 includes, without limitation, four DRAM dies 540(0), 540(1), 540(2), and 540(3). Additionally or alternatively, a multi-die DRAM package 500 can include any number of DRAM dies 540, including 1 DRAM die 540, 2 DRAM dies 540, 4 DRAM dies 540, 8 DRAM dies 540, 16 DRAM dies 540, and/or the like. Each of DRAM dies 540(0), 540(1), 540(2), and 540(3) is configured the same as DRAM device 260 of FIG. 2B. Therefore, DRAM dies 540(0), 540(1), 540(2), and 540(3) are configured to support a 6-bit data bus width.

Each of memory dies 540(0), 540(1), 540(2), and 540(3) is a common die that can be configured in particular ways. For example, as shown, memory dies 540(0), 540(1), 540(2), and 540(3) are configured to support a 6-bit data bus width. In other configurations, memory dies 540(0), 540(1), 540(2), and 540(3) could be configured to support a 12-bit data bus width. Further, each of memory dies 540(0), 540(1), 540(2), and 540(3) can be configured to support the six LSBs of the 12-bit data bus of DRAM package 500 or the six MSBs of the 12-bit data bus of DRAM package 500.

The DRAM dies 540 included in DRAM package 500 can be configured into one or more ranks, in any technically feasible combination. Further, the DRAM dies 540 included in DRAM package 500 can be configured into one or more channels, in any technically feasible combination. As used herein, a rank is a group of DRAM dies that share an address bus, a data bus, chip select signals, and/or the like. As used herein, a channel is a connection between a memory controller and one or more ranks. The memory controller (not shown) is responsible for storing data in and retrieving data from DRAM devices, for configuring DRAM devices, for performing various timing and maintenance functions for DRAM devices, and/or the like. In general, DRAM devices 540 can be organized into one or more ranks, and any one or more ranks can communicate with the memory controller via a single channel or via multiple channels.

As shown, DRAM package 500 includes two ranks. A first rank, referred to as rank 0, includes DRAM dies 540(0) and 540(2). DRAM die 540(0) stores data for the six least significant data bits (LSBs), DQ0-5, for rank 0 of the 12-bit data bus of DRAM package 500. DRAM die 540(2) stores data for the six most significant data bits (MSBs), DQ6-11, for rank 0 of the 12-bit data bus of DRAM package 500. Similarly, a second rank, referred to as rank 1, includes DRAM dies 540(1) and 540(3). DRAM die 540(1) stores data for the six LSBs, DQ0-5, for rank 1 of the 12-bit data bus of DRAM package 500. DRAM die 540(3) stores data for the six MSBs, DQ6-11, for rank 1 of the 12-bit data bus of DRAM package 500.

DQ0-5 bus 510 is the data bus interface for the 6 LSBs of the 12-bit data bus of DRAM package 500. Therefore, DQ0-5 bus 510 connects to DRAM die 540(0), which stores data for the six LSBs for rank 0, and DRAM die 540(1), which stores data for the six LSBs for rank 1. Similarly, RDQS_L WCK_L 520 is the control bus interface for the 6 LSBs of the 12-bit data bus of DRAM package 500. This control bus includes a read data strobe for the 6 LSBs (RDQS_L), a write clock signal for the 6 LSBs (WCK_L), and/or the like. Therefore, RDQS_L WCK_L 520 connects to DRAM die 540(0) and DRAM die 540(1) to route control signals associated with the six LSBs for rank 0 and rank 1, respectively.

DQ6-11 bus 515 is the data bus interface for the 6 MSBs of the 12-bit data bus of DRAM package 500. Therefore, DQ6-11 bus 515 connects to DRAM die 540(2), which stores data for the six MSBs for rank 0, and DRAM die 540(3), which stores data for the six MSBs for rank 1. Similarly, RDQS_U WCK_U 525 is the control bus interface for the 6 MSBs of the 12-bit data bus of DRAM package 500. This control bus includes a read data strobe for the 6 MSBs (RDQS_U), a write clock signal for the 6 MSBs (WCK_U), and/or the like. Therefore, RDQS_U WCK_U 525 connects to DRAM die 540(2) and DRAM die 540(3) to route control signals associated with the six MSBs for rank 0 and rank 1, respectively.

DRAM package 500 can have separate chip select (CS) signals (not shown), where each of the two ranks receives a separate CS signal. A first CS signal provides a chip select for rank 0 and is therefore connected to DRAM die 540(0) and DRAM die 540(2). A second CS signal provides a chip select for rank 1 and is therefore connected to DRAM die 540(1) and DRAM die 540(3). By configuring DRAM die 540(0) and DRAM die 540(1) to route to the data and control signals for the six LSBs and configuring DRAM die 540(2) and DRAM die 540(3) to route to the data and control signals for the six MSBs, the four DRAM dies 540(0), 540(1), 540(2), and 540(3) can be mounted vertically to one another and can be connected to one another via vertically oriented wires. Further, the four DRAM dies 540(0), 540(1), 540(2), and 540(3) can receive commands from a common command (CA) bus 530. Therefore, CA bus 530 connects to all four DRAM dies 540(0), 540(1), 540(2), and 540(3).

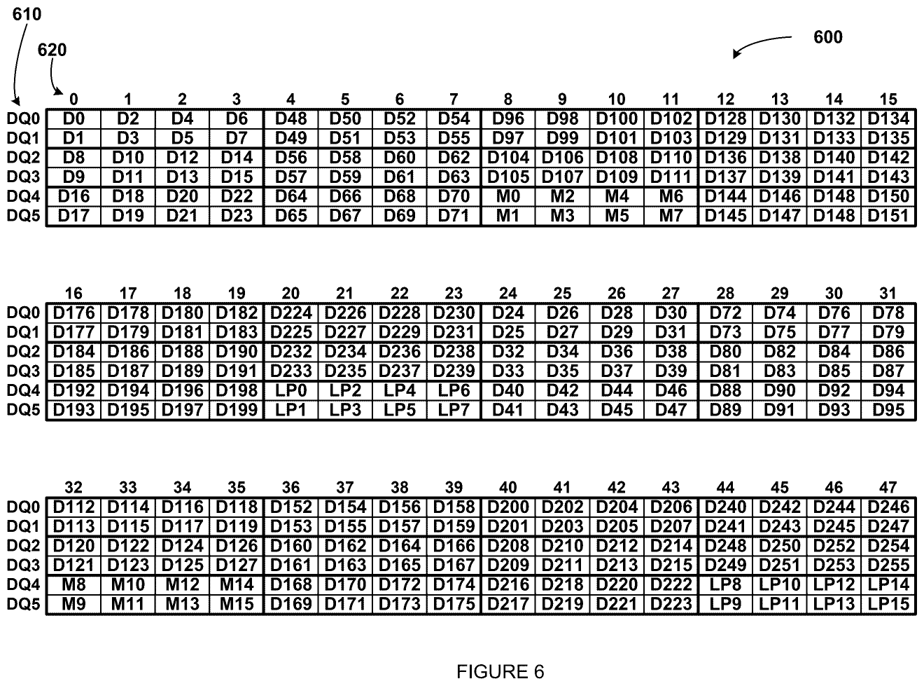

FIG. 6 illustrates a format 600 for DRAM device data transfer with a burst length of 48 beats, according to various embodiments. The DRAM device can be any DRAM device configured with a 6-bit data bus width, such as DRAM device 260 of FIG. 2B, DRAM devices 410 and 460 of FIG. 4, DRAM dies 540(0), 540(1), 540(2), and 540(3) of FIG. 5, and/or the like. As described herein, a conventional DRAM device with a 12-bit data bus width can transfer 288 bits in a single burst with a burst length of 24 beats of 12 bits each. To transfer the same amount of data over a 6-bit data bus, the DRAM device described herein can transfer 288 bits in a single burst with a burst length of 48 beats of 6 bits each. The DRAM device can perform the transfer of the 288 bits using any technically feasible format.

One such format 600 to transfer 288 bits over a 6-bit data bus (DQ5 . . . . DQ0) 610 is shown in FIG. 6. This format 600 illustrates which bits are included in each beat 620 of the burst. The 288 bits of the burst include, without limitation, 256 data bits (labeled D0 through D255) and 32 parameter bits.

Although the beats 620 are shown in FIG. 6 as 3 groups of 16 beats each, the 3 groups are contiguous. As such, the 48 beats 620 of the format 600 can be transferred on 48 consecutive clock cycles. The first beat 620 is labeled ‘0’ and includes data bits D17, D16, D9, D8, D1, and D0, transmitted on DQ5, DQ4, DQ3, DQ2, DQ1, and DQ0, respectively. The second beat 620 is labeled ‘1’ and includes data bits D19, D18, D11, D10, D3, and D2, transmitted on DQ5, DQ4, DQ3, DQ2, DQ1, and DQ0, respectively, and so on.

The 32 parameter bits can include 16 metadata bits (labeled M0 through M15) and/or 16 link protection bits (labeled LP0 through LP15). The 16 metadata bits and/or the 16 link protection bits may or may not be present in any particular burst, in any combination. For example, both the 16 metadata bits and the 16 link protection bits can be present in a particular burst. Additionally or alternatively, the 16 metadata bits can be present and the 16 link protection bits can be absent in a particular burst. Additionally or alternatively, the 16 metadata bits can be absent and the 16 link protection bits can be present in a particular burst. Additionally or alternatively, both the 16 metadata bits and the 16 link protection bits can be absent in a particular burst. If present, the 16 metadata bits can be transmitted on DQ5 and DQ4 of data bus 610 during beats 8 through 11 and beats 32 through 35. If present, the 16 link protection bits can be transmitted on DQ5 and DQ4 of data bus 610 during beats 20 through 23 and beats 44 through 47. When not present, the bits reserved for the 16 metadata bits and/or the 16 link protection bits can be fixed to a low voltage, representing a logic ‘0’ level.

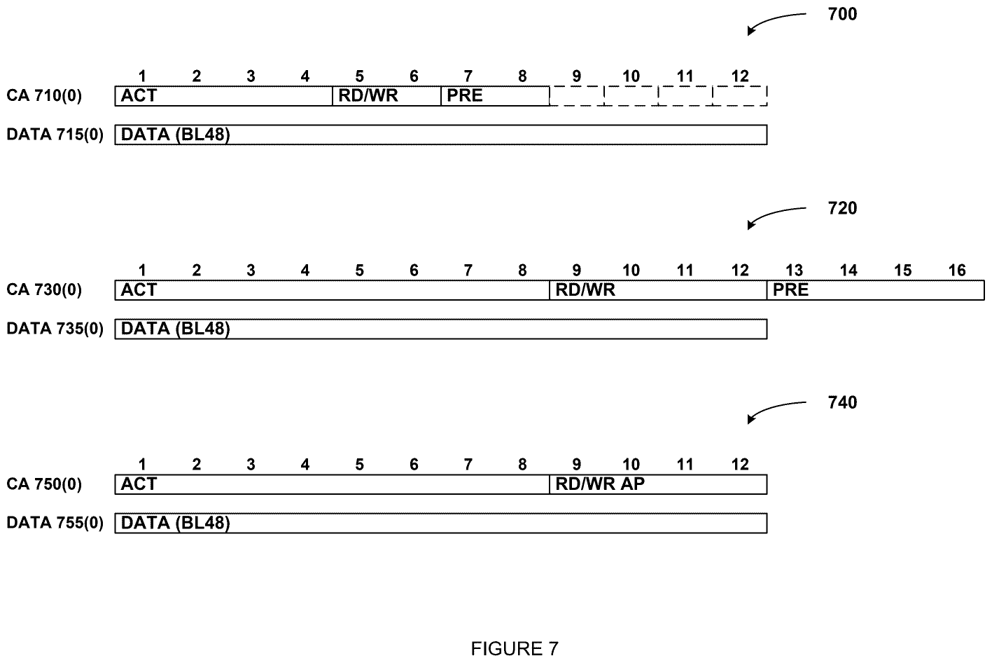

FIG. 7 set forth timing diagrams illustrating command bus optimization for a DRAM device that supports a burst length of 48 beats, according to various embodiments. As shown in timing diagram 700, a DRAM device can be configured to support quad data rate (QDR) data transfers. With QDR, 4 data bits can be transferred on each clock cycle. Therefore, the data for the 48 beats of a burst can be transferred via the data bus 715(0) over 12 clock cycles. Conventionally, commands can be transmitted to the DRAM device via the CA bus 710(0) using dual data rate (DDR) data transfers. With DDR, 2 data bits can be transferred on each clock cycle, one bit on the rising edge of the clock signal and 1 bit on the falling edge of the clock cycle. As a result, the DRAM device can receive an activate (ACT) command during clock cycles 1-4, a read or write command (RD/WR) during clock cycles 5-6, and a precharge (PRE) command for the next DRAM access during clock cycles 7-8. This approach can lead to underutilization of the CA bus 710(0) because the CA bus 710(0) is idle during clock cycles 9-12 while the burst is still transferring data over the data bus 715(0).

For better utilization, timing diagram 720 again shows the data for the 48 beats of a burst transferred via the data bus 735(0) over 12 clock cycles. However, commands are transmitted to the DRAM device via the CA bus 730(0) using single data rate (SDR) data transfers. With SDR, 1 data bit can be transferred on each clock cycle. As a result, each command transfer is twice as long relative to timing diagram 700. Therefore, the DRAM device can receive an activate (ACT) command during clock cycles 1-8, a read or write command (RD/WR) during clock cycles 9-12, and a precharge (PRE) command for the next DRAM access during clock cycles 13-16. This approach can lead to better utilization of the CA bus 730(0) because the CA bus 730(0) is no longer idle while the burst is transferring data over the data bus 735(0).

Timing diagram 700 and timing diagram 720 illustrate data transfers using an open page policy. With an open page policy, the DRAM page remains open, or active, after an access, thereby allowing faster access to the same memory page for the next access, if needed. However, with an open page policy, a precharge cycle may be needed before the next access of DRAM memory. Timing diagram 740 shows the data for the 48 beats of a burst transferred via the data bus 755(0) over 12 clock cycles. Commands are transmitted to the DRAM device via the CA bus 750(0) using single data rate (SDR) data transfers and using a close page policy. With a close page policy, the DRAM page is closed, or rendered inactive, after every access. The DRAM device can receive an activate (ACT) command during clock cycles 1-8 and a combined read or write command (RD/WR) with auto precharge (AP) during clock cycles 9-12. With a close page policy, a separate precharge command is not needed. Consequently, with a close page policy, the data for the burst is transferred via the data bus 755(0) over the same number of clock cycles as the commands transferred via the CA bus 750(0).

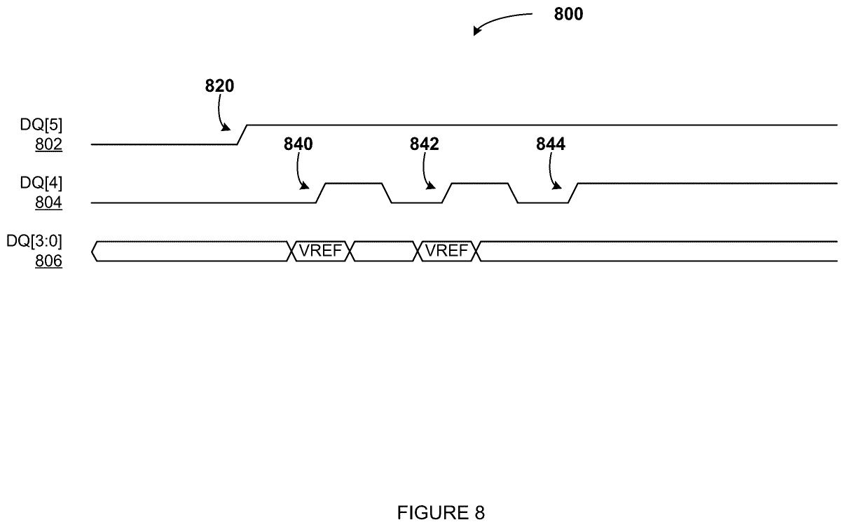

FIG. 8 is a timing diagram 800 illustrating chip select training for a DRAM device with a 6-bit data bus width, according to various embodiments. The chip select (CS) signal enables or disables a DRAM device from performing data transfer functions. Typically, the chip select signal is an active-low signal, such that a low voltage on the chip select signal enables the DRAM device to perform data transfers and a high voltage on the chip select signal disables the DRAM device from performing data transfers. The DRAM device receives the chip select signal from a memory controller that transfers data to and from the DRAM device. The memory controller can perform a chip select training operation on the DRAM device to fine tune the timing of the chip select signal between the memory controller and the DRAM device. By performing chip select training, the memory controller can reduce data transfer times, thereby improving memory performance of the DRAM device.

During a chip select training operation, the memory controller transmits data and control signals to the DRAM device via the data bus interface. When the DRAM device is configured with a 12-bit data bus width, the memory controller can use all 12 bits of the data bus to transmit the data and control signals to the DRAM device. When the DRAM device is configured with a 6-bit data bus width, the memory controller has only 6 bits of the data bus to transmit the same data and control signals to the DRAM device. Consequently, the memory controller transmits data to the DRAM device using fewer bits of the data bus interface. In addition, the memory controller can combine multiple functions into a single control signal.

During the chip select training operation, the memory controller transmits an 8-bit digital representation of a reference voltage (Vref) to the DRAM device. This reference voltage is the voltage that the DRAM device uses to distinguish between a low voltage, representing a logical ‘0’ value, and a high voltage, representing a logical ‘1’ value. The memory controller can test the chip select signal using different reference voltage values to determine which reference voltage value results in the highest signal integrity, the most accurate sampling, and the largest timing margin relative to other candidate reference voltages.

To enter chip select training, the memory controller transmits a particular command sequence to the DRAM device indicating that a chip select training operation is beginning. The memory controller subsequently transmits a rising edge 820 on the DQ[5] 802 data bit to begin the chip select training operation. Because the 8-bit digital representation of the reference voltage has more bits than the 6-bit data bus width, the memory controller cannot transmit the digital representation of the reference voltage in a single step. Rather, the memory controller transmits the digital representation in two steps via four data bits, namely the DQ[3:0] 806 data bits. The memory controller presents 4 of the bits of the digital representation on the DQ[3:0] 806 data bits and transmits a first rising edge 840 on the DQ[4] 804 data bit. The DRAM device samples the 4 bits of the digital representation on the DQ[3:0] 806 data bits using the rising edge 840 on the DQ[4] 804 data bit. The memory controller presents the remaining 4 bits of the digital representation on the DQ[3:0] 806 data bits and transmits a second rising edge 842 on the DQ[4] 804 data bit. The DRAM device samples the remaining 4 bits of the digital representation on the DQ[3:0] 806 data bits using the rising edge 842 on the DQ[4] 804 data bit. After receiving the two 4-bit portions of the digital representation, the DRAM device updates the reference voltage for the chip select signal. The memory controller transmits a third rising edge 844 on the DQ[4] 804 data bit to trigger the DRAM device to transmit comparison results to the memory controller and to reset an internal chip select counter.

The memory controller can repeat the steps of transmitting additional digital representations of other candidate reference voltages and receiving comparison results until the memory controller determines which reference voltage provides the best chip select results. Upon completing the chip select training operation, the memory controller transmits a falling edge (not shown) on the DQ[5] 802 data bit to terminate the chip select training operation.

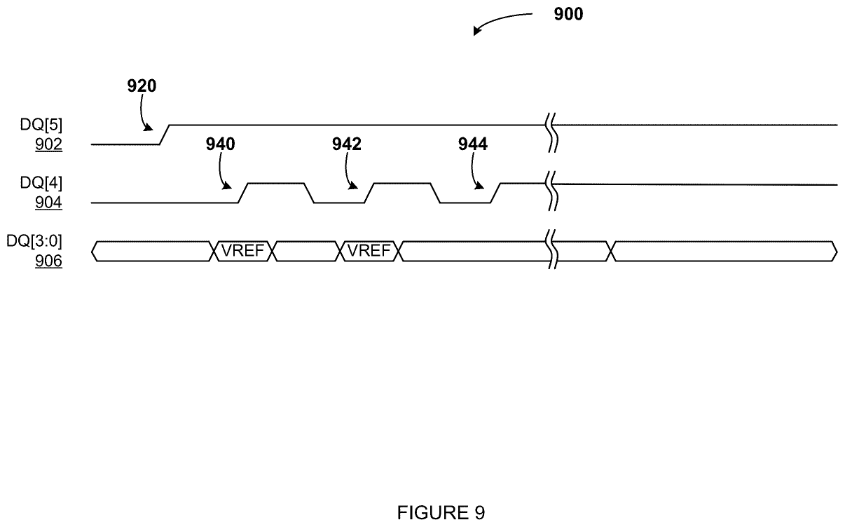

FIG. 9 is a timing diagram 900 illustrating command bus training for a DRAM device with a 6-bit data bus width, according to various embodiments. The command (CA) bus receives commands for the DRAM device from the memory controller. These commands can instruct the DRAM device to perform write operations and read operations directed to the memory core, prefetch operations, chip select training operations, command bus training operations, and/or the like. The memory controller can perform a command bus training operation on the DRAM device to fine tune the timing of the data pins of the command bus between the memory controller and the DRAM device. By performing command bus training, the memory controller can reduce data transfer times, thereby improving memory performance of the DRAM device.

During a command bus training operation, the memory controller transmits data and control signals to the DRAM device via the data bus interface. When the DRAM device is configured with a 12-bit data bus width, the memory controller can use all 12 bits of the data bus to transmit the data and control signals to the DRAM device. When the DRAM device is configured with a 6-bit data bus width, the memory controller has only 6 bits of the data bus to transmit the same data and control signals to the DRAM device. Consequently, the memory controller transmits data to the DRAM device using fewer bits of the data bus interface. In addition, the memory controller can combine multiple functions into a single control signal.

During the command bus training operation, the memory controller transmits an 8-bit digital representation of a reference voltage (Vref) to the DRAM device. This reference voltage is the voltage that the DRAM device uses to distinguish between a low voltage, representing a logical ‘0’ value, and a high voltage, representing a logical ‘1’ value. The memory controller can test the bits of the command bus using different reference voltage values to determine which reference voltage value results in the highest signal integrity, the most accurate sampling, and the largest timing margin relative to other candidate reference voltages.

To enter command bus training, the memory controller transmits a particular command sequence to the DRAM device indicating that a command bus training operation is beginning. The memory controller subsequently transmits a rising edge 920 on the DQ[5] 902 data bit to begin the command bus training operation. Because the 8-bit digital representation of the reference voltage has more bits than the 6-bit data bus width, the memory controller cannot transmit the digital representation of the reference voltage in a single step. Rather, the memory controller transmits the digital representation in two steps via four data bits, namely the DQ[3:0] 906 data bits. The memory controller presents 4 of the bits of the digital representation on the DQ[3:0] 906 data bits and transmits a first rising edge 940 on the DQ[4] 904 data bit. The DRAM device samples the 4 bits of the digital representation on the DQ[3:0] 906 data bits using the rising edge 940 on the DQ[4] 904 data bit. The memory controller presents the remaining 4 bits of the digital representation on the DQ[3:0] 906 data bits and transmits a second rising edge 942 on the DQ[4] 904 data bit. The DRAM device samples the remaining 4 bits of the digital representation on the DQ[3:0] 906 data bits using the rising edge 942 on the DQ[4] 904 data bit. After receiving the two 4-bit portions of the digital representation, the DRAM device updates the reference voltage for the command bus. The memory controller transmits a third rising edge 944 on the DQ[4] 904 data bit to trigger the DRAM device to transmit comparison results to the memory controller and to reset an internal linear feedback shift register (LFSR). This LFSR performs data scrambling operations to increase the reliability of transferring data and commands between the memory controller and the DRAM device.

The memory controller can repeat the steps of transmitting additional digital representations of other candidate reference voltages and receiving comparison results until the memory controller determines which reference voltage provides the best command bus results. Upon completing the command bus training operation, the memory controller transmits a falling edge (not shown) on the DQ[5] 902 data bit to terminate the command bus training operation.

In sum, various embodiments include an improved DRAM device with a common memory die that can be configured with different data bus widths for different applications. The memory device can be configured with a wide data bus width and a specified data burst length. Alternatively, the memory device can be configured with a narrow data bus width that is half of the wide data bus width and a data burst length that is twice the specified data burst length. By doubling the burst length when the data bus width is halved, the two configurations of the memory device maintain the same internal prefetch size. In some examples, the prefetch size of the memory device can be 288 bits. With this prefetch size, the memory device can be configured with a 12-bit data bus width and a burst length of 24 beats or with a 6-bit data bus width and a burst length of 48 beats. Maintaining the same internal prefetch size for these two configurations can simplify the channel control logic for the memory die.

Further, the common die can be packaged into different configurations. For example, the package for the common memory die includes multiple read data strobes and write clock pins, thereby allowing read data strobe inputs and write clock inputs of the memory die to be routed to different pins of the memory device package. Similarly, the common memory die can include an internal data bus that allows, for example, all 12 bits to be routed to pins of the memory device package or only 6 of the 12 bits to be routed to pins of the memory device package. In this latter configuration, the memory die includes a mode whereby either the six most significant data pins or the six least significant data pins of the 12-bit data bus can be selected to route to pins of the memory device package.

These package options allow more memory devices to be placed on a single rank, thereby doubling memory capacity without increasing surface area of the memory device package. As a result, higher memory capacity can be achieved without increasing the surface area of the package, thereby providing additional memory capacity for applications that need large amounts of memory, such as data servers in a data center.

At least one technical advantage of the disclosed techniques relative to the prior art is that, with the disclosed techniques, a common die can be configured with a wide data bus width or with a narrow data bus width that is half the bus width relative to the wide data bus width. Further, by doubling the data burst length when the data bus width is halved, the same internal prefetch size can be maintained. By contrast, conventional approaches maintain the same burst length when the data bus width is halved, thereby reducing channel efficiency by 50%. Further, packaging for this common die can include additional read data strobes, write clocks, and data bus pinout options, making the resulting package easier to stack vertically and achieving even higher memory density at the system level. With these techniques, a single common DRAM memory die can be configured and packaged to accommodate different data bus widths for different applications without appreciably increasing channel logic complexity or die surface area. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A memory device, comprising:
a first memory die, comprising:
a first memory core;
a first prefetch buffer coupled to the first memory core and configured to store data for at least a portion of the first memory core; and
a first data bus interface coupled to the first prefetch buffer and configurable to have one of a first bit width or a second bit width,
wherein:
when configured to have the first bit width, the first data bus interface transfers data between the first prefetch buffer and an external device as a burst of data transfers with a first burst length, and
when configured to have the second bit width, the first data bus interface transfers data between the first prefetch buffer and the external device as a burst of data transfers with a second burst length that is different from the first burst length.

2. The memory device of claim 1, wherein the first bit width is 12 bits and the second bit width is 6 bits.

3. The memory device of claim 1, wherein the first burst length is 24 and the second burst length is 48.

4. The memory device of claim 1, wherein:
the memory device further comprises a second memory die that is substantially similar to the first memory die, the second memory die comprising a second data bus interface configurable to have the first bit width or the second bit width,
the first data bus interface is connected to a first set of connections on the first memory die,
the second data bus interface is connected to a second set of connections on the second memory die, and
a physical location of the first set of connections on the first memory die is different from a physical location of the second set of connections on the second memory die.

5. The memory device of claim 4, wherein the first die and the second die are vertically stacked in a physical package of the memory device.

6. The memory device of claim 4, wherein the first memory die comprises a first rank of the memory device and the second memory die comprises a second rank of the memory device.

7. The memory device of claim 4, wherein the first memory die and the second memory die comprise a first rank of the memory device.

8. The memory device of claim 1, wherein whether the first data bus interface is configured to have the first bit width or the second bit width is based on a hardwired component included in the memory die.

9. The memory device of claim 1, wherein whether the first data bus interface is configured to have the first bit width or the second bit width is based on a value stored in one or more bits of a programmable register included in the memory die.

10. The memory device of claim 1, wherein, when the memory device is in a training mode:
a memory controller transmits a first portion of a digital representation of a voltage reference via a portion of the first data bus interface at a first time, and
the memory controller transmits a second portion of the digital representation of the voltage reference via the portion of the first data bus interface at a second time.

11. A system, comprising:
a memory controller; and
a memory device coupled to the memory controller, wherein the memory device comprises:
a first memory die, comprising:
a memory core,
a prefetch buffer coupled to the memory core and configured to store data for at least a portion of the memory core, and
a data bus interface configurable to have one of a first bit width or a second bit width,
wherein:
when configured to have the first bit width, the data bus interface transfers data between the prefetch buffer and the memory controller as a burst of data transfers with a first burst length, and
when configured to have the second bit width, the data bus interface transfers data between the prefetch buffer and the memory controller as a burst of data transfers with a second burst length that is different from the first burst length.

12. The system of claim 11, wherein the first bit width is 12 bits and the second bit width is 6 bits.

13. The system of claim 11, wherein the first burst length is 24 and the second burst length is 48.

14. The system of claim 11, wherein:
the memory device further comprises a second memory die that is substantially similar to the first memory die, the second memory die comprising a second data bus interface configurable to have the first bit width or the second bit width,
the first data bus interface is connected to a first set of connections on the first memory die,
the second data bus interface is connected to a second set of connections on the second memory die, and
a physical location of the first set of connections on the first memory die is different from a physical location of the second set of connections on the second memory die.

15. The system of claim 14, wherein the first die and the second die are vertically stacked in a physical package of the memory device.

16. The system of claim 14, wherein the first memory die comprises a first rank of the memory device and the second memory die comprises a second rank of the memory device.

17. The system of claim 14, wherein the first memory die and the second memory die comprise a first rank of the memory device.

18. The system of claim 11, wherein whether the first data bus interface is configured to have the first bit width or the second bit width is based on a hardwired component included in the first memory die.

19. The system of claim 11, wherein whether the first data bus interface is configured to have the first bit width or the second bit width is based on a value stored in one or more bits of a programmable register included in the first memory die.

20. The system of claim 11, wherein, when the memory device is in a training mode:
a memory controller transmits a first portion of a digital representation of a voltage reference via a portion of the first data bus interface at a first time, and
the memory controller transmits a second portion of the digital representation of the voltage reference via the portion of the first data bus interface at a second time.
